(19) United States
(12) Patent Application Publication
(10) Pub. No.: US 2026/0289003 A1
(43) Pub. Date: Sep. 24, 2026

(54) A SYSTEM FOR PRIVACY PROTECTED IDENTITY AND PROFILING PREVENTION AND A METHOD THEREOF

(71) Applicant: PRIVASAPIEN TECHNOLOGIES PRIVATE LIMITED, Bengaluru (IN)

(72) Inventor: Abilash Soundararajan, Bangalore (IN)

(21) Appl. No.: 19/473,583

(22) PCT Filed: Apr. 8, 2024
(86) PCT No.: PCT/IB2024/053436

§ 371 Date: Oct. 8, 2025

(30) Foreign Application Priority Data
Apr. 10, 2023 (IN) 202341026573

(51) Int. Cl. G06F 21/62; H04L 9/32

(52) U.S. Cl. CPC G06F 21/6245; H04L 9/32

(57) ABSTRACT

A system 100 for privacy protected identity and profiling prevention in a responsible artificial intelligence ecosystems is disclosed. The system includes a user registration module 114 to register a user with a unique identity and authenticate the user, a generative artificial intelligence ecosystem integration module 116 receives sensitive information, provides privacy protected aggregate identity, accepts queries, connects the registered user with a plurality of downstream modules, performs a privacy threat modelling, comprehends a plurality of sensitive identities, and aggregates usage of a user's data, a profiling prevention module 120 identifies general sensitive information, annotate the identified information, a pseudo-identity mapping module 122 generates tokenized data and pseudonymized data for encryption and decrypting information, a secure key management module 124 generates a secure key for generating shares of the secure key, and a notification module 126 notifies the user regarding a database usage of the user by a third party.

### EARLIEST PRIORITY DATE

This Application claims priority from a provisional patent application filed in India having Patent Application No. 202341026573, filed on Apr. 10, 2023, and titled “SYSTEM AND METHOD FOR PRIVACY PROTECTED IDENTITY AND PROFILING PREVENTION FOR GENERATIVE AI ECOSYSTEMS” and PCT application filed having Patent Application No. PCT/IB2024/053436, filed on Apr. 8, 2024, and titled “A SYSTEM FOR PRIVACY PROTECTED IDENTITY AND PROFILING PREVENTION AND A METHOD THEREOF”

### FIELD OF INVENTION

Embodiments of a present disclosure relate to artificial intelligence governance platform and more particularly to a system for privacy protected identity and profiling prevention and a method thereof.

### BACKGROUND

Privacy-protected identity and profiling prevention refers to the set of measures and practices aimed at safeguarding user's personal information from unauthorized access, misuse, and profiling. The privacy protection involves protecting sensitive data associated with a user, such as user identity, preferences, behaviours, and activities, as well as other personal and non-personal data such an organizational data shared by the user from being exploited for purposes including but not limited to targeted advertising, model training, model inference without consent as well as identity theft, or discrimination. Profiling prevention is crucial for upholding user privacy rights, promoting fairness and equality, maintaining data security, and fostering trust in a digital ecosystem. By implementing measures to prevent profiling, organizations can demonstrate their commitment to responsible data practices and respect for privacy and autonomy of individuals as well as organizations.

The current systems and methods are with algorithmic bias and discrimination which leads to unfair treatment or exclusion of certain groups based on demographic characteristics or past behaviours. In the current systems when the user submits the queries to generative artificial intelligence (AI) and other AI ecosystems, they can be aggregated based on individual identity to profile individuals. The data shared by users may contain sensitive information regarding the user, other individuals or organizations, which may violate the privacy of those in concern when used downstream tasks including Retrieval Augmented Generation (RAG), model training, etc. Further, the current system does not provide effective privacy protection to the user data.

Hence, there is a need for a system for privacy protected identity and profiling prevention and a method thereof which addresses the aforementioned issues.

### OBJECTIVE OF THE INVENTION

An objective of the present invention is to provide a system privacy protected identity and profiling prevention in a responsible artificial intelligence ecosystems.

Another objective of the present invention is to protect the original identity of users from these external artificial intelligence entities while also privacy preserving any data shared by the user.

Yet, another objective of present invention is to help in having a seamless experience across AI pipelines without sacrificing privacy.

Further, an objective of the present invention is to aggregate the user identities to avoid fragmented experience of the user.

### BRIEF DESCRIPTION

In accordance with one embodiment of the disclosure, a system for privacy protected identity and profiling prevention in a responsible artificial intelligence ecosystems is provided. The system includes at least one processor, at least one memory. The at least one processor in communication with a client processor. The at least one memory includes a set of program instructions in the form of a processing subsystem and configured to be executed by the at least one processor. The processing subsystem is hosted on a server and configured to execute on a network to control bidirectional communications among a plurality of modules. The processing subsystem includes a user registration module, a generative artificial intelligence ecosystem integration module, a profiling prevention module, the pseudo-identity mapping module, a secure key management module, and a notification module. The user registration module is configured to register a user with a unique identity and authenticate the user at a multi-factor authentication levels by providing two or more verification factors to gain access while log in. The generative artificial intelligence ecosystem integration module is operatively coupled with the user registration module. The generative artificial intelligence ecosystem integration module is configured to receive sensitive information shared by the registered user through at least of ways prompts and through document submission for retrieval augmented generation along with prompts for a downstream neural network with attention based artificial intelligence model. The generative artificial intelligence ecosystem integration module is also configured to provide privacy protected aggregate identity which protects the original identity or sensitive information shared by users in generative artificial intelligence ecosystem. Further, the generative artificial intelligence ecosystem integration module is configured to accepts queries and related uploaded documents of various forms for non-parametric storage and inference by downstream neural network with attention based artificial intelligence model for use of methods like retrieval augmented generation. Furthermore, the generative artificial intelligence ecosystem integration module is configured to connect the registered user with a plurality of downstream modules for collecting a plurality of data from the user and comprehend a risk associated in the plurality of data collected. Furthermore, the generative artificial intelligence ecosystem integration module is configured to perform a privacy threat modelling for classifying a personally identifiable information present in the plurality of data by at least one of a named entity recognition (NER) using neural network models, pattern matching, database lookup for consumption of an artificial intelligence model. Furthermore, the generative artificial intelligence ecosystem integration module is configured to comprehend a plurality of sensitive identities and a plurality of sensitive attributes to be protected. Furthermore, the generative artificial intelligence ecosystem integration module is configured to aggregate usage of a user's data as part of pseudonymization and re-identification across different downstream systems. The profiling prevention module is operatively coupled with the generative artificial intelligence ecosystem integration module. The profiling prevention module is configured to identify general sensitive information and organization specific sensitive information, annotate the identified information using a generative artificial intelligence ecosystem to prevent profiling by unauthorized systems and hence send the annotated information along with the shared data to the pseudo-identity mapping module. The pseudo-identity mapping module is operatively coupled with profiling prevention module. The pseudo-identity mapping module is configured to generate synthetic sensitive attributes for a one-on-one token generation, mapping, and storage to create tokenized data from multiple possible sources with the plurality of sensitive attributes in the data. The secure key management module operatively coupled with the pseudo-identity mapping module. The secure key management module is configured to generate a secure key by via a secure key generation or secure multiparty computation for generating one or more shares of the secure key to prevent decryption of the user's personally identifiable information. The pseudo-identity mapping module is configured to generate pseudonymized data by encrypting the annotated sensitive data by using the generated secure key for encryption and decrypting this data when authorisation is provided by the method of key sharing for re-identification. The notification module is operatively coupled with the profiling prevention module. The notification module is configured to notify the user regarding a database usage of the user by a third party. The notification is sent to the user related to at least one of personal identified identities and potential profiling by a re-identification authorising user. The privacy preserved data, either by the method of tokenization or by the authorized access of re-identified data via decryption, is passed downstream for consumption by downstream neural network with attention based artificial intelligence model for use of methods like retrieval augmented generation (RAG).

In accordance with another embodiment a method for operating a system for privacy protected identity and profiling prevention in a responsible artificial intelligence ecosystem is provided. The method includes registering and authenticating, by a user registration module of a processing subsystem, a user with a unique identity and authenticate the user at a multi-factor authentication level by providing two or more verification factors to gain access while log in. The method also includes receiving, by a generative artificial intelligence ecosystem integration module of a processing subsystem, information shared by registered user through at least of ways prompts and through document submission for retrieval augmented generation along with prompts and a downstream neural network based with attention based artificial intelligence model. Further, the method includes, providing, by the generative artificial intelligence ecosystem integration module, of a processing subsystem privacy protected aggregate identity which protects the original identity or sensitive information shared by users in generative artificial intelligence ecosystem. Furthermore, the method includes accepting, by the generative artificial intelligence ecosystem integration module, queries, and related uploaded documents of various forms for non-parametric storage and inference by downstream neural network with attention based artificial intelligence model for use of methods like retrieval augmented generation. Furthermore, the method includes connecting, by a generative artificial intelligence ecosystem integration module of the processing subsystem, the registered user with a plurality of downstream modules for collecting a plurality of data from the user and comprehend a risk associated in the plurality of data collected. Furthermore, the method includes performing, by the generative artificial intelligence ecosystem integration module of the processing subsystem, a privacy threat modelling for classifying a personally identifiable information present in the plurality of data by methods including but not limited to named entity recognition (NER) using neural network with attention based artificial intelligence models, pattern matching, database lookup for consumption of a downstream artificial intelligence model. Furthermore, the method includes comprehending, by the generative artificial intelligence ecosystem integration module of the processing subsystem, a plurality of sensitive identities and a plurality of sensitive attributes to be protected. Furthermore, the method includes aggregating usage of a user's data as part of pseudonymization and re-identification across different downstream systems. Furthermore, the method includes identifying, by a profiling prevention module of the processing subsystem, general sensitive information, and organization specific sensitive information, annotate the identified information using a generative artificial intelligence ecosystem to prevent profiling by unauthorized systems and hence send the annotated information along with the shared data to the pseudo-identity mapping module. Furthermore, the method includes generating, by a pseudo-identity mapping module of the processing subsystem, synthetic sensitive attributes for one-on-one token generation, mapping and storage to create tokenized data from multiple possible sources with the plurality of sensitive attributes of the data. Furthermore, the method includes generating, by a secure key management module of the processing subsystem, a secure key by via a secure multiparty computation for generating one or more shares of the secure key to prevent decryption of the user's personally identifiable information. Furthermore, the method includes generating, by a pseudo-identity mapping module of the processing subsystem, pseudonymized data by encrypting the annotated sensitive data by using the generated secure key for encryption and decrypting this data when authorisation is provided by the usage of secure key for re-identification. Furthermore, the method includes notifying, by a notification module of the processing subsystem, the user regarding a database usage of the user by a third party, wherein the notification is sent to the user is related to at least one of personal identified identities and potential profiling by a re-identification authorising user. Furthermore, the method includes passing, the privacy preserved data, either by method of tokenization or by the authorized access of re-identified data via decryption, to downstream for consumption by downstream neural network with attention based artificial intelligence model for use of methods like retrieval augmented generation.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for privacy protected identity and profiling prevention in accordance with an embodiment of the present disclosure;

FIG. 2 is a block diagram of representing an exemplary embodiment of the system for privacy protected identity and profiling prevention;

FIG. 3 is a block diagram of a computer or a server for representing the system for privacy protected identity and profiling prevention in accordance with an embodiment of the present disclosure;

FIG. 4a is a flowchart representing steps involved in a method for operating a system for privacy protected identity and profiling prevention in accordance with an embodiment of the present disclosure; and

FIG. 4b is a illustrates continuous steps involved in a method for operating a system for privacy protected identity and profiling prevention of FIG. 4a in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for privacy protected identity and profiling prevention in a responsible artificial intelligence ecosystems is provided. The system includes at least one processor, at least one memory. The at least one processor in communication with a client processor. The at least one memory includes a set of program instructions in the form of a processing subsystem and configured to be executed by the at least one processor. The processing subsystem is hosted on a server and configured to execute on a network to control bidirectional communications among a plurality of modules. The processing subsystem includes a user registration module, a generative artificial intelligence ecosystem integration module, a profiling prevention module, the pseudo-identity mapping module, a secure key management module, and a notification module. The user registration module is configured to register a user with a unique identity and authenticate the user at a multi-factor authentication levels by providing two or more verification factors to gain access while log in. The generative artificial intelligence ecosystem integration module is operatively coupled with the user registration module. The generative artificial intelligence ecosystem integration module is configured to receive sensitive information shared by the registered user through at least of ways prompts and through document submission for retrieval augmented generation along with prompts for a downstream neural network with attention based artificial intelligence model. The generative artificial intelligence ecosystem integration module is also configured to provide privacy protected aggregate identity which protects the original identity or sensitive information shared by users in generative artificial intelligence ecosystem. Further, the generative artificial intelligence ecosystem integration module is configured to accepts queries and related uploaded documents of various forms for non-parametric storage and inference by downstream neural network based artificial intelligence model for use of methods like retrieval augmented generation (RAG). Furthermore, the generative artificial intelligence ecosystem integration module is configured to connect the registered user with a plurality of downstream modules for collecting a plurality of data from the user and comprehend a risk associated in the plurality of data collected. perform a privacy threat modelling for classifying a personally identifiable information present in the plurality of data by methods including but not limited to named entity recognition (NER) using neural network models, pattern matching, database lookup for consumption of an artificial intelligence model. Furthermore, the generative artificial intelligence ecosystem integration module is configured to comprehend a plurality of sensitive identities and a plurality of sensitive attributes to be protected. Furthermore, the generative artificial intelligence ecosystem integration module is configured to aggregate usage of a user's data as part of pseudonymization and re-identification across different downstream systems. The profiling prevention module is operatively coupled with the generative artificial intelligence ecosystem integration module. The profiling prevention module is configured to identify general sensitive information and organization specific sensitive information, annotate the identified information using a generative artificial intelligence ecosystem to prevent profiling by unauthorized systems and hence send the annotated information along with the shared data to the pseudo-identity mapping module. The pseudo-identity mapping module is operatively coupled with profiling prevention module. The pseudo-identity mapping module is configured to generate synthetic sensitive attributes for one-on-one token generation, mapping and storage to create tokenized data from multiple possible sources with the plurality of sensitive attributes of the data. The secure key management module operatively coupled with the pseudo-identity mapping module. The secure key management module is configured to generate a secure key by via a secure key generation or secure multiparty computation for generating one or more shares of the secure key to prevent decryption of the user's personally identifiable information. The pseudo-identity mapping module is configured to generate pseudonymized data by encrypting the annotated sensitive data by using the generated sensitive data by using the generated secure key for encryption and decrypting this data when authorisation is provided by the usage of secure key for re-identification. The notification module is operatively coupled with the profiling prevention module. The notification module is configured to notify the user regarding a database usage of the user by a third party. The notification is sent to the user is related to at least one of personal identified identities and potential profiling by a re-identification authorising user. The privacy preserved data, either by the method of tokenization or by the authorized access of re-identified data via decryption, is passed downstream for consumption by downstream neural network based artificial intelligence model for use of methods like retrieval augmented generation.

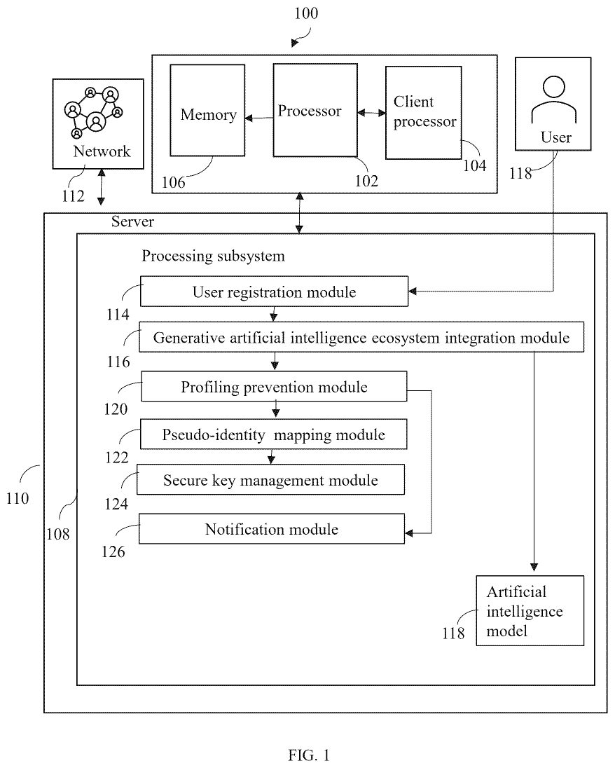

FIG. 1 is a block diagram representing a system 100 for privacy protected identity and profiling prevention in accordance with an embodiment of the present disclosure. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The system 100 includes at least one processor 102 and a memory 106. The at least one processor 102 is in communication with a client processor 104. The at least one processor 102 generally refers to a computational unit or central processing unit (CPU) responsible for executing instructions in a computer system. The phrase “in communication with a client processor” implies that there is a relationship or interaction between at least one processor and a specific type of processor referred to as a “client processor.” Here, the term “client processor” refer to a processor that initiates requests or tasks and interacts with another processor (which may be a server processor) to fulfil those requests.

The memory 106 includes a set of instructions in the form of a processing subsystem 108, configured to be executed by the at least one processor 102. The processing subsystem 108 is hosted on a server 110 and configured to execute on a network 112 to control bidirectional communications among a plurality of modules. In one embodiment, the server 110 may include a cloud server. In another embodiment, the server 110 may include a local server. In one embodiment, the network 112 may include a wired network such as a local area network (LAN). In another embodiment, the network may include a wireless network such as Wi-Fi, Bluetooth, Zigbee, near-field communication (NFC), infrared communication (RFID), or the like.

The plurality of modules includes a user registration module 114, a generative artificial intelligence ecosystem integration module 116, a profiling prevention module 120, the pseudo-identity mapping module 122, a secure key management module 124, and a notification module 126. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The user registration module 114 configured to register a user with a unique identity and authenticate the user at a multi-factor authentication levels by providing two or more verification factors to gain access while log in. The user registration module 114 is designed to handle user inputs along with the personal information of the user and authenticate the user with multifactor-authentication. In one embodiment, multi-level authentication (MLA) involves using multiple factors to verify the identity of a user before granting access to a system, application, or service. The multi-factors of authentication may include something the user knows such as passwords and security questions, something the user has such as security tokens and smart cards, and something the user is such as fingerprint recognitions, facial recognition, retina scanning, and the like. In one embodiment, the multi-level authentication involves combining two or more of these factors to create a layered security approach. For example, a system may require a user to enter a password and then use a security token or undergo biometric verification for additional verification. This adds an extra layer of security beyond traditional single-factor authentication methods, making it more difficult for unauthorized users to gain access to sensitive systems or data.

The generative artificial intelligence ecosystem integration module 116 is operatively coupled with the user registration module. The generative artificial intelligence ecosystem integration module 116 is configured to receive sensitive information shared by the registered user through at least of ways prompts and through document submission for retrieval augmented generation along with prompts for a downstream neural network with attention based artificial intelligence model 118. The generative artificial intelligence ecosystem integration module 116 is also configured to provide privacy protected aggregate identity which protects the original identity or sensitive information shared by users in generative artificial intelligence ecosystem. Further, the generative artificial intelligence ecosystem integration module 116 is configured to accept queries and related uploaded documents of various forms for non-parametric storage and inference by downstream neural network with attention based artificial intelligence model 118 for use of methods like retrieval augmented generation. Furthermore, the generative artificial intelligence ecosystem integration module 116 is configured to connect the registered user with a plurality of downstream modules for collecting a plurality of data from the user and comprehend a risk associated in the plurality of data collected.

Moreover, the generative artificial intelligence ecosystem integration module 116 is configured to perform a privacy threat modelling for classifying a personally identifiable information present in the plurality of data by methods including but not limited to named entity recognition (NER) using neural network with attention based artificial intelligence models, pattern matching, database lookup for consumption of an artificial intelligence model. Moreover, the generative artificial intelligence ecosystem integration module 116 is configured to comprehend a plurality of sensitive identities and a plurality of sensitive attributes to be protected. Moreover, the generative artificial intelligence ecosystem integration module 116 is configured to aggregate usage of a user's data as part of pseudonymization and re-identification across different downstream systems.

The profiling prevention module 120 is operatively coupled with the generative artificial intelligence ecosystem integration module 116. The profiling prevention module 120 is configured general sensitive information and organization specific sensitive information, annotate the identified information using a generative artificial intelligence ecosystem to prevent profiling by unauthorized systems and hence send the annotated information along with the shared data to the pseudo-identity mapping module

The pseudo-identity mapping module 122 is operatively coupled with profiling prevention module 120. The pseudo-identity mapping module 122 is configured to generate synthetic sensitive attributes for one-on-one token generation, mapping and storage to create tokenized data from multiple possible sources with the plurality of sensitive attributes of the data.

The secure key management module 124 is operatively coupled with the pseudo-identity mapping module 122. The secure key management module 124 is configured to generate a secure key by via a secure key generation or secure multiparty computation for generating one or more shares of the secure key to prevent decryption of the user's personally identifiable information.

The pseudo-identity mapping module is configured to generate pseudonymized data by encrypting the annotated sensitive data by using the generated secure key for encryption and decrypting this data when authorisation is provided by the usage of secure key for re-identification.

The notification module 126 is operatively coupled with the profiling prevention module 120. The notification module 126 is configured to notify the user regarding a database usage of the user by a third party. The notification is sent to the user is related to at least one of personal identified identities and potential profiling by a re-identification authorising user. In one embodiment, the notification module 126 notifies the user in case of presence of sensitive information, pseudonymization of attributes in the document before submitting into the retrieval augmented generation, request for reveal in case of pseudonymized information is present in the foundational model response, success or failure of re-identification, need for approvals in case of insufficient threshold cryptographic approvers needed or any other configured permission failure or system failure.

The privacy preserved data, either by the method of tokenization or by the authorized access of re-identified data via decryption, is passed downstream for consumption by downstream neural network with attention based artificial intelligence model for use of methods like retrieval augmented generation.

Consider a non-limiting example where a data of a user X is collected for retrieval augmented generation. After data collection, the privacy preservation of the data is conducted using privacy-enhancing technologies (PET). The privacy preserved data is then fed to a downstream large language model for retrieval augmented generation (RAG). This deployed model is protected at prompt level and the user level. This protection is important to avoid breaches at the user level. The governance of the AI model is carried out and reports are generated regarding risks related to the data.

Consider a non-limiting example where, a user X registers and authenticates and starts using the system. In the generative AI ecosystem, the user X may connect with multiple downstream modules. Within the generative artificial intelligence ecosystem integration module, the data is parallelly processed by the neural network-based named entity recognition model which detects entities based on contexts and the real time database validator model which detect known entities by cross checking with a database in real-time based on patterns. The pseudo-identity mapping module generates the synthetic entities corresponding to the information that need to be protected or pseudonymised. This mapping is used to create pseudonymized version of the shared data. The secure key management module generates and manages the secure key. A cryptographic encryption is used to generate pseudonymized data by encrypting the annotated data which is stored in the database using a secure key. The secure key management module may use secure multi-party compute (SMPC) to generate multiple shares of key. For example, a K1 has divided into s1, s2, and s3 and stored separately to not to get back to K1. When all the keys are present only then the K1 can be converted to “ABCD” till this no one can re-identify the name. For re-identification, the user consent or legal ground is need. All the keys are stored in a zero-knowledge storage and processing module. The pseudonymised data is mapped with an attribute. For example, of the user X enters a string and the system changed it to a cryptographic value and this data is provided for downstream tasks involving AI. For example:
User X: “ABCD” is eating in “XYZ” hotel.
System: “pqrs” is going to “lmn” hotel.
Tokenized Data for Downstream Tasks: “pqrs” is going to “lmn” hotel.
Encryption Key Shares: s1, s2, s3
Encrypted Data

Such data is provided for downstream tasks involving AI models including Retrieval Augmented Generation (RAG). If there is question by the user who is going to hotel, the model may reply which may not violate privacy. Based on the pseudonymised data usage, a notification is sent to the user. For example, if the data of a loan department is being used for downstream tasks involving AI models including Retrieval Augmented Generation. The notification is sent to the loan department, saying, which data is used for downstream tasks involving AI models including RAG, which identities are identified, which method of profiling prevention is possible. Also, the notification is sent in case of re-identification of the encrypted data is happen. The notification is sent to an authorized user who is authorizing the system flow. Thus, helps in privacy protection of the data. All these information is captured in the logs.

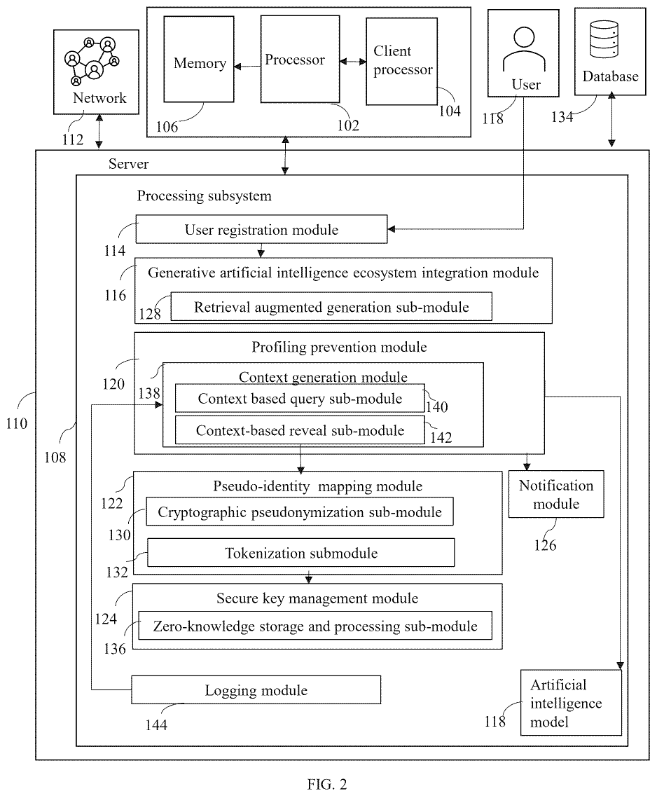

FIG. 2 is a block diagram of representing an exemplary embodiment of the system 100 for privacy protected identity and profiling prevention. The generative artificial intelligence ecosystem integration module 116 includes of a retrieval augmented generation sub-module 128. The retrieval augmented generation (RAG) sub-module 128 is configured to integrate intelligent annotation of internal and external sensitive information. The retrieval augmented generation sub-module 128 is also configured to integrate intelligent annotation of internal and external sensitive information de-identify through cryptographic or tokenized pseudonymization and context-based reveal enables users to have retrieval augmented generation with assessment and mitigation.

In one embodiment, the pseudo-identity mapping module 122 includes a cryptographic pseudonymization sub-module 130. The cryptographic pseudonymization sub-module 130 is configured to connect with secure key management module 124 to receive standard cryptographic keys or secure multi-party compute-based threshold cryptographic keys for cryptographic pseudonymization. In another embodiment, the pseudo-identity mapping module 122 includes of a tokenization sub-module 132 and is configured to create synthetic pseudo-token for de-identification and re-identification where the mapping information is stored in a database 134 suitable for fast and scalable retrieval of tokenized information.

In one embodiment, the secure key management module 124 includes of a zero-knowledge storage and processing sub-module 136. The only the cryptographic commitment for decryption by multiple parties in a threshold cryptographic setup is stored and the actual decryption key is not stored in the system. The stored threshold cryptographic setup serves as proof of achieving minimum threshold for decryption is stored, while achieving completeness by allowing the access upon minimum number of users consent, soundness by ensuring the user with a true secret share able contribute to achieve a threshold and zero knowledge by ensuring no reusable knowledge about the secret shares are stored on the platform.

In one embodiment, the profiling prevention module 120 includes a context management module 138, for identifying the context of the inbound query or document from the user including domain of the information, sensitive information in the input, risk categorization of the input and checks admin configuration for allowed contexts for the user, thus taking a decision to either allow or block the query and additional non-parametric information into the system. In one embodiment, the context management module 138 includes a context based query sub-module 140 for identifying the context of the inbound query or document from the user including domain of the information, sensitive information in the input, risk categorization of the input and admin configuration for allowed contexts for the user and then recommends a decision to either allow with appropriate technical safeguard or block the query and additional non-parametric information into the system.

In one embodiment, the context management module 138 includes of a context based query sub-module 140 for identifying the context of the inbound query or document from the user including domain of the information, sensitive information in the input, risk categorization of the input and admin configuration for allowed contexts for the user and then recommends a decision to either allow with appropriate technical safeguard or block the query and additional non-parametric information into the system. In another embodiment, the context management module 138 includes a context-based reveal sub-module 142 is operatively coupled with the pseudo-identity mapping module 122. The pseudo-identity mapping module 122 a response from a downstream foundational artificial intelligence module to the user, which may contain de-identified information, checks if the user has necessary context based right to request for a context-based reveal function. In one embodiment, the context-based reveal module sub module 142 fetches the re-identified information if requested to reveal by user and has right to reveal, based on tagged information for cryptographic pseudonymization or tokenized pseudonymization by calling the pseudo-identity mapping module 122, enabling identification of the sensitive information to the user.

In one embodiment, the system 100 includes a logging module 144 operatively coupled to the context generation module 138. The logging module 144 is configured to log the pseudonymized data, a data related to re-identification, data related to the re-identification authorising user, and data related to the notification in case of an illegal re-identification.

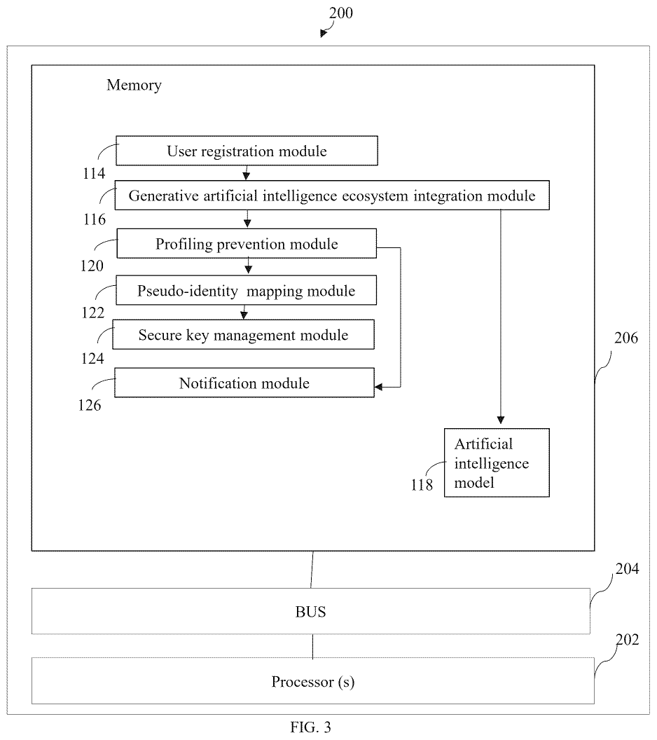

FIG. 3 is a block diagram 200 of a computer or a server for multi modal aggregation and governance platform in a responsible artificial intelligence in accordance with an embodiment of the present disclosure. The server includes a processor(s) 202, and memory 202 is operatively coupled to the bus 204.

The processor(s) as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 204 as used herein refers to be internal memory channels or computer network that is used to connect computer components and transfer data between them. The bus 204 includes a serial bus or a parallel bus, wherein the serial bus transmits data in a bit-serial format and the parallel bus transmits data across multiple wires. The bus 204 as used herein, may include but not limited to, a system bus, an internal bus, an external bus, an expansion bus, a frontside bus, a backside Bus, and the Like.

The memory 206 includes a plurality of subsystems and a plurality of modules stored in the form of an executable program which instructs the processor to the system illustrated in FIG. 1. The memory 206 is substantially similar for the system for for privacy protected identity and profiling prevention in a responsible artificial intelligence ecosystems of FIG. 1. The memory 206 has submodules a user registration module 114, a generative artificial intelligence ecosystem integration module 116, a profiling prevention module 120, the pseudo-identity mapping module 122, a secure key management module 124, and a notification module 126.

The user registration module is configured to register a user with a unique identity and authenticate the user at a multi-factor authentication levels by providing two or more verification factors to gain access while log in.

The generative artificial intelligence ecosystem integration module 116 is operatively coupled with the user registration module. The generative artificial intelligence ecosystem integration module 116 is configured to receive sensitive information shared by the registered user through at least of ways prompts and through document submission for retrieval augmented generation along with prompts for a downstream neural network with attention based artificial intelligence model 118. The generative artificial intelligence ecosystem integration module 116 is also configured to provide privacy protected aggregate identity which protects the original identity or sensitive information shared by users in generative artificial intelligence ecosystem. Further, the generative artificial intelligence ecosystem integration module 116 is configured to accepts queries and related uploaded documents of various forms for non-parametric storage and inference by downstream neural network with attention based artificial intelligence model 118 for use of methods like retrieval augmented generation. Furthermore, the generative artificial intelligence ecosystem integration module 116 is configured to connect the registered user with a plurality of downstream modules for collecting a plurality of data from the user and comprehend a risk associated in the plurality of data collected.

Moreover, the generative artificial intelligence ecosystem integration module 116 is configured to perform a privacy threat modelling for classifying a personally identifiable information present in the plurality of data by methods including but not limited to named entity recognition (NER) using neural network with attention artificial intelligence models, pattern matching, database lookup for consumption of an artificial intelligence model. Moreover, the generative artificial intelligence ecosystem integration module 116 is configured to comprehend a plurality of sensitive identities and a plurality of sensitive attributes to be protected. Moreover, the generative artificial intelligence ecosystem integration module 116 is configured to aggregate usage of a user's data as part of pseudonymization and re-identification across different downstream systems.

The profiling prevention module 120 is operatively coupled with the generative artificial intelligence ecosystem integration module 116. The profiling prevention module 120 is configured to identify general sensitive information and organization specific sensitive information, annotate the identified information using a generative artificial intelligence ecosystem to prevent profiling by unauthorized systems and hence send the annotated information along with the shared data to the pseudo-identity mapping module 122.

The pseudo-identity mapping module 122 is operatively coupled with profiling prevention module 120. The pseudo-identity mapping module 122 is configured to generate synthetic sensitive attributes for one-on-one token generation, mapping and storage to create tokenized data from multiple possible sources with the plurality of sensitive attributes of the data.

The secure key management module 124 is operatively coupled with the pseudo-identity mapping module 122. The secure key management module 124 is configured to generate a secure key by via a secure key generation or secure multiparty computation for generating one or more shares of the secure key to prevent decryption of the user's personally identifiable information.

The pseudo-identity mapping module 122 is configured to generate pseudonymized data by encrypting the annotated sensitive data by using the generated sensitive data by using the generated secure key for encryption and decrypting this data when authorisation is provided by the usage of secure key for re-identification.

The notification module 126 is operatively coupled with the profiling prevention module 120. The notification module 126 is configured to notify the user regarding a database usage of the user by a third party. The notification is sent to the user is related to at least one of personal identified identities and potential profiling by a re-identification authorising user.

The privacy preserved data, either by the method of tokenization or by the authorized access of re-identified data via decryption, is passed downstream for consumption by downstream neural network with attention based artificial intelligence model 118 for use of methods like retrieval augmented generation.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) 202.

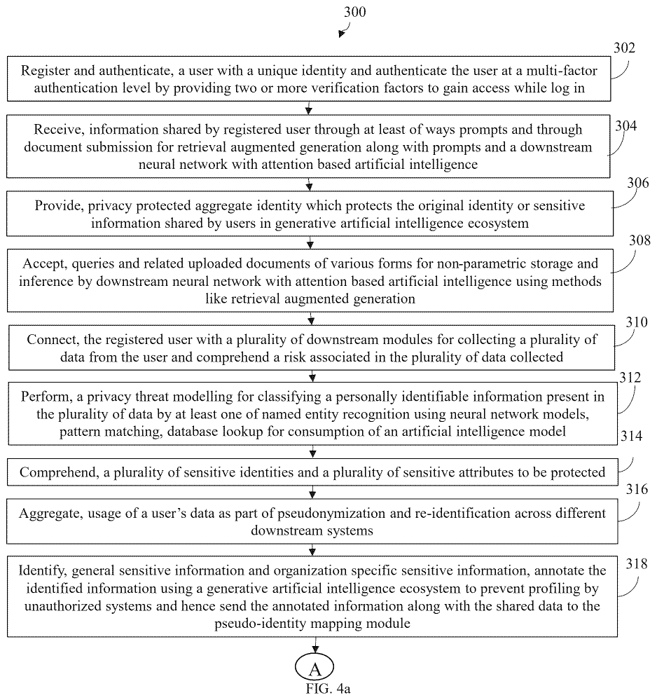

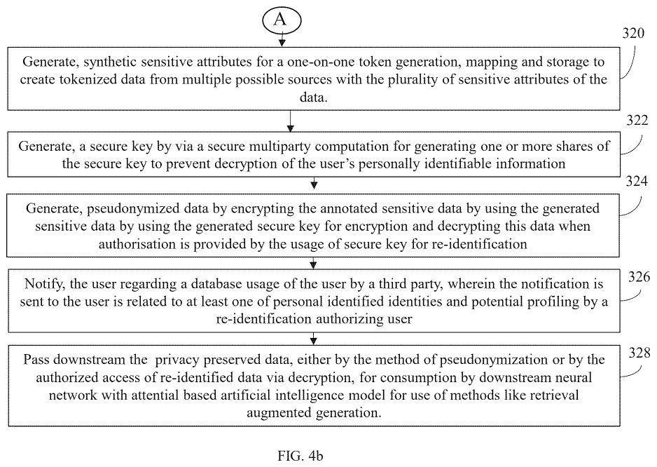

FIG. 4a is a flowchart representing steps involved in a method for operating a system for privacy protected identity and profiling prevention in accordance with an embodiment of the present disclosure and FIG. 4b is a illustrates continuous steps involved in a method for operating a system for privacy protected identity and profiling prevention of FIG. 4b in accordance with an embodiment of the present disclosure.

The method 300 includes registering and authenticating, by a user registration module of a processing subsystem, a user with a unique identity and authenticate the user at a multi-factor authentication level by providing two or more verification factors to gain access while log in in step 302.

The method 300 also includes receiving, by a generative artificial intelligence ecosystem integration module of a processing subsystem, information shared by registered user through at least of ways prompts and through document submission for retrieval augmented generation along with prompts and a downstream neural network with attention based artificial intelligence model in step 304.

Further, the method 300 includes providing, by the generative artificial intelligence ecosystem integration module of a processing subsystem, privacy protected aggregate identity which protects the original identity or sensitive information shared by users in generative artificial intelligence ecosystem in step 306.

Furthermore, the method 300 includes accepting, by the generative artificial intelligence ecosystem integration module, queries and related uploaded documents of various forms for non-parametric storage and inference by downstream neural network with attention based artificial intelligence model for use of methods like retrieval augmented generation in step 308.

Moreover, the method 300 includes connecting, by the generative artificial intelligence ecosystem integration module of the processing subsystem, the registered user with a plurality of downstream modules for collecting a plurality of data from the user and comprehend a risk associated in the plurality of data collected in step 310. The method 300 also includes de-identifying, through cryptographic or tokenized pseudonymization and context-based reveal enables users to have retrieval augmented generation with assessment and mitigation.

Moreover, the method 300 includes performing, by the generative artificial intelligence ecosystem integration module of the processing subsystem, a privacy threat modelling for classifying a personally identifiable information present in the plurality of data by methods including but not limited to named entity recognition (NER) using neural network with attention based artificial intelligence models, pattern matching, database lookup for consumption of an artificial intelligence model in step 312.

Moreover, the method 300 includes comprehending, by the generative artificial intelligence ecosystem integration module of the processing subsystem, a plurality of sensitive identities and a plurality of sensitive attributes to be protected in step 314.

Moreover, the method 300 includes aggregating, by the generative artificial intelligence ecosystem integration module of the processing subsystem, usage of a user's data as part of pseudonymization and re-identification across different downstream systems in step 316. The method 300 includes integrating, intelligent annotation of internal and external sensitive information.

Moreover, the method 300 includes identifying, by a profiling prevention module of the processing subsystem, general sensitive information and organization specific sensitive information, annotate the identified information using a generative artificial intelligence ecosystem to prevent profiling by unauthorized systems and hence send the annotated information along with the shared data to the pseudo-identity mapping module in step 318.

Moreover, the method 300 also includes identifying, by a context management module, the context of the inbound query or document from the user including domain of the information, sensitive information in the input, risk categorization of the input and checks admin configuration for allowed contexts for the user, thus taking a decision to either allow or block the query and additional non-parametric information into the system. The method 300 also includes identifying, by a context-based query sub-module, the context of the inbound query or document from the user including domain of the information, sensitive information in the input, risk categorization of the input and admin configuration for allowed contexts for the user and then recommends a decision to either allow with appropriate technical safeguard or block the query and additional non-parametric information into the system.

In one embodiment, the context-based reveal sub-module takes a response from a downstream foundational artificial intelligence module to the user, which may contain de-identified information, checks if the user has necessary context based right to request for a context-based reveal function. The method 300 also includes fetching, the re-identified information based on tagged information for cryptographic pseudonymization or tokenized pseudonymization by calling the pseudo-identity mapping module enabling identification of the sensitive information to the user if requested to reveal by user and has right to reveal. The method also includes logging, by a logging module, the pseudonymized data, a data related to re-identification, data related to the re-identification authorising user, and data related to the notification in case of an illegal re-identification.

Moreover, the method 300 includes generating, by a pseudo-identity mapping module of the processing subsystem, synthetic sensitive attributes for one-on-one token generation, mapping, and storage to create tokenized data from multiple possible sources with the plurality of sensitive attributes of the data in step 320.

Moreover, the method 300 includes generating, by a secure key management module of the processing subsystem, a secure key by via a secure multiparty computation for generating one or more shares of the secure key to prevent decryption of the user's personally identifiable information in step 322.

Moreover, the method 300 includes generating, by a pseudo-identity mapping module of the processing subsystem, pseudonymized data by encrypting the annotated sensitive data by using the generated sensitive data by using the generated secure key for encryption and decrypting this data when authorisation is provided by the usage of secure key for re-identification in step 324. The method 300 also includes connecting, by a cryptographic pseudonymization sub-module the cryptographic pseudonymization sub-module with the secure key management module to receive standard cryptographic keys or secure multi-party compute-based threshold cryptographic keys for cryptographic pseudonymization.

In one embodiment, the method 300 also includes creating, by a tokenization sub-module, synthetic pseudo-token for de-identification and re-identification where the mapping information is stored in a database suitable for fast and scalable retrieval of tokenized information.

The method 300 also includes storing, by a zero-knowledge storage and processing sub-module, only the cryptographic commitment for decryption by multiple parties in a threshold cryptographic setup. The method also includes discarding, the storage of the actual decryption key. In one embodiment, the stored threshold cryptographic setup serves as proof of achieving minimum threshold for decryption is stored, while achieving completeness by allowing the access upon minimum number of users consent, soundness by ensuring the user with a true secret share able contribute to achieve a threshold and zero knowledge by ensuring no reusable knowledge about the secret shares are stored on the platform.

Moreover, the method 300 includes notifying, by a notification module of the processing subsystem, the user regarding a database usage of the user by a third party, wherein the notification is sent to the user is related to at least one of personal identified identities and potential profiling by a re-identification authorising user in step 326. The method 300 also includes notifying, the user in case of presence of sensitive information, pseudonymization of attributes in the document before submitting into the retrieval augmented generation, request for reveal in case of pseudonymized information is present in the foundational model response, success, or failure of re-identification, need for approvals in case of insufficient threshold cryptographic approvers needed or any other configured permission failure or system failure.

Moreover, the method 300 includes passing, downstream privacy preserved data, either by the method of pseudonymization or by the authorized access of re-identified data via decryption, for consumption by downstream neural network with attention based artificial intelligence model for use of methods like retrieval augmented generation in step 328.

Various embodiments of the present disclosure provides a system for privacy protected identity and profiling prevention in a responsible artificial intelligence ecosystems. The generative artificial intelligence ecosystem integration module of the system disclosed in the present disclosure provides a privacy protected aggregate identity which protects the original identity or sensitive information shared by users in generative artificial intelligence ecosystem. Also, the generative artificial intelligence ecosystem integration module perform a privacy threat modelling for classifying personally identifiable information present in the plurality of data and comprehend a plurality of sensitive identities and a plurality of sensitive attributes to be protected. The profiling prevention module disclosed in the present disclosure, identifies general sensitive information and organization specific sensitive information, annotate the identified information using a generative artificial intelligence ecosystem to prevent profiling by unauthorized systems. The pseudo-identity mapping module disclosed in the present disclosure generates a secure key for encryption and decrypting information as required and map the pseudonymized data from a multiple platforms with the plurality of sensitive attributes of the data.

Further, the secure key management module of the computer-implement system prevents decryption of the user's personally identifiable information by generating a secure key. The notification module disclosed in the present disclosure notifies the user regarding a database usage by a third party. The notification is sent to the user is related to personal identified identities and potential profiling by a re-identification authorising user. Also, the notification is sent in case of re-identification of the encrypted data is happen. The notification is sent to an authorized user who is authorizing the system flow. Thus, helps in privacy protection of the data.

The privacy preserved data, either by the method of tokenization or by the authorized access of re-identified data via decryption, is passed downstream for consumption by downstream neural network with attention based artificial intelligence model for use of methods like retrieval augmented generation.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for privacy protected identity and profiling prevention in a responsible artificial intelligence ecosystems:
at least one processor in communication with a client processor; and
at least one memory comprises a set of program instructions in the form of a processing subsystem, configured to be executed by the at least one processor, wherein the processing subsystem is hosted on a server and configured to execute on a network to control bidirectional communications among a plurality of modules comprising:
a user registration module configured to register a user with a unique identity and authenticate the user at a multi-factor authentication levels by providing two or more verification factors to gain access while log in;
a generative artificial intelligence ecosystem integration module operatively coupled with the user registration module, wherein the generative artificial intelligence ecosystem integration module is configured to:
receive sensitive information shared by the registered user through at least of ways prompts and through document submission for retrieval augmented generation along with prompts and a downstream neural network with attention based artificial intelligence model;
provide privacy protected aggregate identity which protects the original identity or sensitive information shared by users in generative artificial intelligence ecosystem;
accept queries and related uploaded documents of various forms for non-parametric storage and inference by downstream neural network with attention based artificial intelligence model for use of methods like retrieval augmented generation;
connect the registered user with a plurality of downstream modules for collecting a plurality of data from the user and comprehend a risk associated in the plurality of data collected; and
perform a privacy threat modelling for classifying a personally identifiable information present in the plurality of data by at least one of named entity recognition using neural network with attention based artificial intelligence models, pattern matching, database lookup for consumption of an artificial intelligence model;
comprehend a plurality of sensitive identities and a plurality of sensitive attributes to be protected; and
aggregate usage of a user's data as part of pseudonymization and re-identification across different downstream systems;
a profiling prevention module operatively coupled with the generative artificial intelligence ecosystem integration module, wherein the profiling prevention module is configured to identify general sensitive information and organization specific sensitive information, annotate the identified information using a generative artificial intelligence ecosystem to prevent profiling by unauthorized systems and hence send the annotated information along with the shared data to the a pseudo-identity mapping module;
the pseudo-identity mapping module operatively coupled with profiling prevention module, wherein the pseudo-identity mapping module is configured to:
generate pseudonymized data by encrypting the annotated sensitive data by using the generated secure key to generate synthetic sensitive attributes for one-on-one token generation, mapping and storage to create tokenized data from multiple possible sources with the plurality of sensitive attributes of the data and
generate pseudonymized data by encrypting the annotated sensitive data by using the generated sensitive data by using the generated secure key for encryption and decrypting this data when authorisation is provided by the usage of secure key for re-identification;
a secure key management module operatively coupled with the pseudo-identity mapping module, wherein the secure key management module is configured to generate a secure key by via a secure key generation or secure multiparty computation for generating one or more shares of the secure key to prevent decryption of the user's personally identifiable information; and
a notification module operatively coupled with the profiling prevention module, wherein the notification module is configured to notify the user regarding a database usage of the user by a third party, wherein the notification is sent to the user is related to at least one of personal identified identities and potential profiling by a re-identification authorising user.

2. The system as claimed in claim 1, wherein the generative artificial intelligence ecosystem integration module comprises of a retrieval augmented generation sub-module configured to:
integrate intelligent annotation of internal and external sensitive information; and
de-identify through cryptographic or tokenized pseudonymization and context-based reveal enables users to have retrieval augmented generation with assessment and mitigation.

3. The system as claimed in claim 1, wherein the pseudo-identity mapping module comprises a cryptographic pseudonymization sub-module, wherein the cryptographic pseudonymization sub-module is configured to connect with the secure key management module to receive standard cryptographic keys or secure multi-party compute-based threshold cryptographic keys for cryptographic pseudonymization.

4. The system as claimed in claim 1, wherein the pseudo-identity mapping module comprises of a tokenization sub-module and is configured to create synthetic pseudo-token for de-identification and re-identification where the mapping information is stored in a database suitable for fast and scalable retrieval of tokenized information.

5. The system as claimed in claim 1, wherein the secure key management module comprises of a zero-knowledge storage and processing sub-module,
wherein the only the cryptographic commitment for decryption by multiple parties in a threshold cryptographic setup is stored and discard the storage of the actual decryption key, and
wherein the stored threshold cryptographic setup serves as proof of achieving minimum threshold for decryption is stored, while achieving completeness by allowing the access upon minimum number of users consent, soundness by ensuring the user with a true secret share able contribute to achieve a threshold and zero knowledge by ensuring no reusable knowledge about the secret shares are stored on the platform.

6. The system as claimed in claim 1, wherein the profiling prevention module comprises a context management module, for identifying the context of the inbound query or document from the user including domain of the information, sensitive information in the input, risk categorization of the input and checks admin configuration for allowed contexts for the user, thus taking a decision to either allow or block the query and additional non-parametric information into the system.

7. The system as claimed in claim 6, wherein the context management module comprises a context based query sub-module for identifying the context of the inbound query or document from the user including domain of the information, sensitive information in the input, risk categorization of the input and admin configuration for allowed contexts for the user and then recommends a decision to either allow with appropriate technical safeguard or block the query and additional non-parametric information into the system.

8. The system as claimed in claim 6, wherein the context management module comprises a context-based reveal sub-module operatively coupled with the pseudo-identity mapping module and that takes a response from a downstream foundational artificial intelligence module to the user, which may contain de-identified information, checks if the user has necessary context based right to request for a context-based reveal function,
wherein the module fetches the re-identified information based on tagged information for cryptographic pseudonymization or tokenized pseudonymization by calling the pseudo-identity mapping module, enabling identification of the sensitive information to the user, if requested to reveal by user and has right to reveal.

9. The system as claimed in claim 6, comprises a logging module operatively coupled to the context generation module configured to log the pseudonymized data, a data related to re-identification, data related to the re-identification authorising user, and data related to the notification in case of an illegal re-identification.

10. The system as claimed in claim 1, wherein the notification module notifies the user in case of presence of sensitive information, pseudonymization of attributes in the document before submitting into the retrieval augmented generation, request for reveal in case of pseudonymized information is present in the foundational model response, success or failure of re-identification, need for approvals in case of insufficient threshold cryptographic approvers needed or any other configured permission failure or system failure.

11. A method comprising:
registering and authenticating, by a user registration module of a processing subsystem, a user with a unique identity and authenticate the user at a multi-factor authentication level by providing two or more verification factors to gain access while log in;
receiving, by a generative artificial intelligence ecosystem integration module of a processing subsystem, information shared by registered user through at least of ways prompts and through document submission for retrieval augmented generation along with prompts and a downstream neural network with attention based artificial intelligence model;
providing, by the generative artificial intelligence ecosystem integration module of a processing subsystem, privacy protected aggregate identity which protects the original identity or sensitive information shared by users in generative artificial intelligence ecosystem;
accepting, by the generative artificial intelligence ecosystem integration module, queries, and related uploaded documents of various forms for non-parametric storage and inference by downstream neural network with attention based artificial intelligence model for use of methods like retrieval augmented generation;
connecting, by a generative artificial intelligence ecosystem integration module of the processing subsystem, the registered user with a plurality of downstream modules for collecting a plurality of data from the user and comprehend a risk associated in the plurality of data collected;
performing, by the generative artificial intelligence ecosystem integration module of the processing subsystem, a privacy threat modelling for classifying a personally identifiable information present in the plurality of data by at least one of named entity recognition using neural network models, pattern matching, database lookup for consumption of an artificial intelligence model;
comprehending, by the generative artificial intelligence ecosystem integration module of the processing subsystem, a plurality of sensitive identities and a plurality of sensitive attributes to be protected;
aggregating, by the generative artificial intelligence ecosystem integration module of the processing subsystem, usage of a user's data as part of pseudonymization and re-identification across different downstream systems;
identifying, by a profiling prevention module of the processing subsystem, general sensitive information and organization specific sensitive information, annotate the identified information using a generative artificial intelligence ecosystem to prevent profiling by unauthorized systems and hence send the annotated information along with the shared data to the pseudo-identity mapping module;
generating, by a pseudo-identity mapping module of the processing subsystem, synthetic sensitive attributes for one-on-one token generation, mapping and storage to create tokenized data from multiple possible sources with the plurality of sensitive attributes of the data;
generating, by a secure key management module of the processing subsystem, a secure key by via a secure multiparty computation for generating one or more shares of the secure key to prevent decryption of the user's personally identifiable information;
generating, by a pseudo-identity mapping module of the processing subsystem, pseudonymized data by encrypting the annotated sensitive data by using the generated sensitive data by using the generated secure key for encryption and decrypting this data when authorisation is provided by the usage of secure key for re-identification
notifying, by a notification module of the processing subsystem, the user regarding a database usage of the user by a third party, wherein the notification is sent to the user is related to at least one of personal identified identities and potential profiling by a re-identification authorising user; and
passing, downstream privacy preserved data, either by the method of pseudonymization or by the authorized access of re-identified data via decryption, for consumption by downstream neural network with attention based artificial intelligence model for use of methods like retrieval augmented generation.
